(19) United States
(12) Patent Application Publication
(10) Pub. No.: US 2026/0268061 A1
(43) Pub. Date: Sep. 10, 2026

(54) ANALYSIS APPARATUS, ANALYSIS PROGRAM, METHOD, SEMICONDUCTOR DEVICE, AND SEMICONDUCTOR WAFER

(71) Applicant: DENSO CORPORATION, Kariya-city (JP)

(72) Inventor: Hidetake SUGO, Kariya-city (JP)

(21) Appl. No.: 19/669,296

(22) Filed: May 6, 2026

Related U.S. Application Data
(63) Continuation of application No. PCT/JP2024/024520, filed on Jul. 8, 2024.

(30) Foreign Application Priority Data
Dec. 19, 2023 (JP) 2023-214013

(51) Int. Cl. G06F 30/398; G01R 31/28; G06F 119/10

(52) U.S. Cl. CPC G06F 30/398; G01R 31/28; G06F 2119/10

(57) ABSTRACT

An analysis apparatus executes an analysis process for electromagnetic noise performance of a sample. The analysis apparatus is configured to generate a model having a noise performance value of the electromagnetic noise performance of a first sample as a response variable and having multiple product characteristic values of the first sample as explanatory variables. The analysis apparatus is configured to input multiple product characteristic values of a second sample to the explanatory variables of the model, and configured to output data related to analysis of the electromagnetic noise performance of the second sample by using the model. The multiple product characteristic values of the second sample correspond to the multiple product characteristic values of the first sample.

### CROSS REFERENCE TO RELATED APPLICATION

This application is a continuation application of International Patent Application No. PCT/JP2024/024520 filed on Jul. 8, 2024, which designated the U.S. and claims the benefit of priority from Japanese Patent Application No. 2023-214013 filed on Dec. 19, 2023. The entire disclosures of all of the above applications are incorporated herein by reference.

### TECHNICAL FIELD

The present disclosure relates to a technique for analyzing electromagnetic noise performance of an electrical product, an electronic product, or the like.

### BACKGROUND

Techniques for analyzing electromagnetic noise performance of an electrical product, an electronic product, or the like are known.

### SUMMARY

According to one aspect of the present disclosure, an analysis apparatus may execute an analysis process for electromagnetic noise performance of a sample. The analysis apparatus may generate a model having a noise performance value of the electromagnetic noise performance of a first sample as a response variable and having multiple product characteristic values of the first sample as explanatory variables. The analysis apparatus may input multiple product characteristic values of a second sample to the explanatory variables of the model and may output data related to analysis of the electromagnetic noise performance of the second sample by using the model. The multiple product characteristic values of the second sample may correspond to the multiple product characteristic values of the first sample.

### BRIEF DESCRIPTION OF DRAWINGS

FIG. 1 is a schematic configuration diagram of a system for analyzing electromagnetic noise performance.

FIG. 2 is a configuration diagram for describing functions of an analysis apparatus.

FIG. 3 is a flowchart showing an example of a model generation process.

FIG. 4 is a flowchart showing an example of a prediction process.

FIG. 5 is a flowchart showing an example of a process for multiple frequencies.

FIG. 6 is a graph showing appearance rates as explanatory variables.

FIG. 7 is a graph showing traveling wave power and a maximum difference in each sample group.

FIG. 8 is a graph showing traveling wave power and a maximum difference in each sample group.

FIG. 9 is a top view showing an example of a semiconductor chip including a measurement circuit.

FIG. 10 is a top view showing an example of a semiconductor chip including a measurement circuit.

FIG. 11 is a diagram showing an example of a semiconductor wafer including a measurement circuit.

FIG. 12 is an enlarged view enlarging a portion XII in FIG. 11.

FIG. 13 is a diagram corresponding to FIG. 12 and showing another example of a semiconductor wafer.

### DETAILED DESCRIPTION

Techniques for analyzing electromagnetic noise performance of an electrical product, an electronic product, or the like are known. For example, there is a technique for specifying a frequency of electromagnetic noise that causes a malfunction in a product.

In the technique described above, while it is possible to specify a malfunction and a frequency for which countermeasures should be taken, it is not possible to analyze and specify a cause such as a malfunction source or a malfunction mechanism. As a result, there is a concern that analysis of the product takes many man-hours.

It is an object of the present disclosure to provide an analysis apparatus, an analysis program, a method, a semiconductor device, and a semiconductor wafer that reduce or prevent an increase in man-hours required for analysis of a product.

According to a first aspect of the present disclosure, an analysis apparatus configured to execute an analysis process for electromagnetic noise performance of a sample comprises: a model generation unit configured to generate a model having a noise performance value of the electromagnetic noise performance of a first sample as a response variable and having a plurality of product characteristic values of the first sample as explanatory variables; and an output unit configured to input a plurality of product characteristic values of a second sample different from the first sample to the explanatory variables of the model, and configured to output data related to analysis of the electromagnetic noise performance of the second sample by using the model, wherein the plurality of product characteristic values of the second sample corresponds to the plurality of product characteristic values of the first sample.

According to a second aspect of the present disclosure, an analysis program configured to execute an analysis process for electromagnetic noise performance of a sample by using at least one processor causes the at least one processor to execute: generating a model having a noise performance value of the electromagnetic noise performance of a first sample as a response variable and having a plurality of product characteristic values of the first sample as explanatory variables; and inputting a plurality of product characteristic values of a second sample different from the first sample to the explanatory variables of the model, and outputting data related to analysis of the electromagnetic noise performance of the second sample by using the model, wherein the plurality of product characteristic values of the second sample corresponds to the plurality of product characteristic values of the first sample.

According to a third aspect of the present disclosure, a method for generating data related to electromagnetic noise performance of a sample comprises: generating a model having a noise performance value of the electromagnetic noise performance of a first sample as a response variable and having a plurality of product characteristic values of the first sample as explanatory variables; and inputting a plurality of product characteristic values of a second sample different from the first sample to the explanatory variables of the model, and generating data related to analysis of the electromagnetic noise performance of the second sample by using the model, wherein the plurality of product characteristic values of the second sample corresponds to the plurality of product characteristic values of the first sample.

According to the above, the model is generated using the first sample, and the data related to the electromagnetic noise performance of the second sample is obtained using the generated model. That is, it becomes possible to easily analyze the electromagnetic noise performance of the second sample different from the first sample based on information of the first sample.

The generated model is a model having the noise performance value of the electromagnetic noise performance as the response variable and having the product characteristic values of the first sample as the explanatory variables. By inputting the product characteristic values of the second sample to this model in place of the first sample, it is possible to obtain data related to analysis. Specifically, by analyzing basic characteristics that determine the electromagnetic noise performance of the second sample, it is possible to easily identify a cause of malfunction. As a result, an increase in man-hours required for analysis of the product can be reduced or prevented.

According to a fourth aspect of the present disclosure, an analysis apparatus configured to execute an analysis process for electromagnetic noise performance of a sample comprises: a model generation unit configured to generate a model having a noise performance value of the electromagnetic noise performance of a first sample as a response variable and having a plurality of product characteristic values of the first sample as explanatory variables; and an output unit configured to input a plurality of product characteristic values of the first sample to the explanatory variables of the model, and configured to output data related to analysis of the electromagnetic noise performance of the first sample by using the model.

According to the above, the model is generated using the first sample, and the data related to the electromagnetic noise performance is outputted by inputting the product characteristic values of the first sample to the generated model. Thus, it is possible to easily verify whether the generated model is abnormal. As a result, an increase in man-hours required for analysis of the product can be reduced or prevented.

According to a fifth aspect of the present disclosure, an analysis apparatus configured to execute an analysis process for electromagnetic noise performance of a sample comprises: a memory configured to store data related to analysis of the electromagnetic noise performance regarding samples; and a sample extraction unit configured to extract, with respect to a condition optionally given, a sample having electromagnetic noise performance satisfying the condition from among the samples stored in the memory.

According to the above, since a corresponding sample can be easily extracted by designating the condition, an increase in man-hours required for analysis of the product can be reduced or prevented.

According to a sixth aspect of the present disclosure, a semiconductor device configured such that measurement of a product characteristic value for analyzing electromagnetic noise performance is performable comprises: a substrate for mounting a circuit; a measurement circuit that is a circuit for measuring the product characteristic value, and that is different from a product circuit that is a circuit for exhibiting a functionality of a product; and an output terminal configured to output a result of measurement by the measurement circuit.

According to the above, since the measurement circuit is provided in the semiconductor device and the measurement result of the product characteristic value can be obtained from the measurement circuit through the output terminal, an increase in man-hours required for analysis of the product can be reduced or prevented.

According to a seventh aspect of the present disclosure, a semiconductor wafer configured such that measurement of a product characteristic value for analyzing electromagnetic noise performance is performable comprises: a plurality of dies configured such that a product circuit being a circuit for exhibiting a functionality of a product is mountable in each die, the plurality of dies being arranged so as to be spaced apart from each other with a scribe region therebetween; and a plurality of measurement circuits that are circuits for measuring the product characteristic value, the plurality of measurement circuits being arranged in the scribe region so as to have respective correspondence relationship with the plurality of dies.

According to the above, since the measurement results of the product characteristic values can be obtained through the measurement circuits having the respective correspondence relationship with the multiple dies, an increase in man-hours required for analysis of the product including an influence on each die of the wafer can be reduced or prevented.

Hereinafter, multiple embodiments will be described based on the drawings. In respective embodiments, corresponding constituent elements may be denoted by the same reference numerals, and redundant description may be omitted. When only a part of a configuration is described in a respective embodiment, configurations of other embodiments described previously can be applied to other parts of the configuration. Further, other than combinations of configurations explicitly stated in the description of each embodiment, configurations of multiple embodiments can be partially combined with each other even if not explicitly stated, provided that no particular trouble occurs in the combination.

### First Embodiment

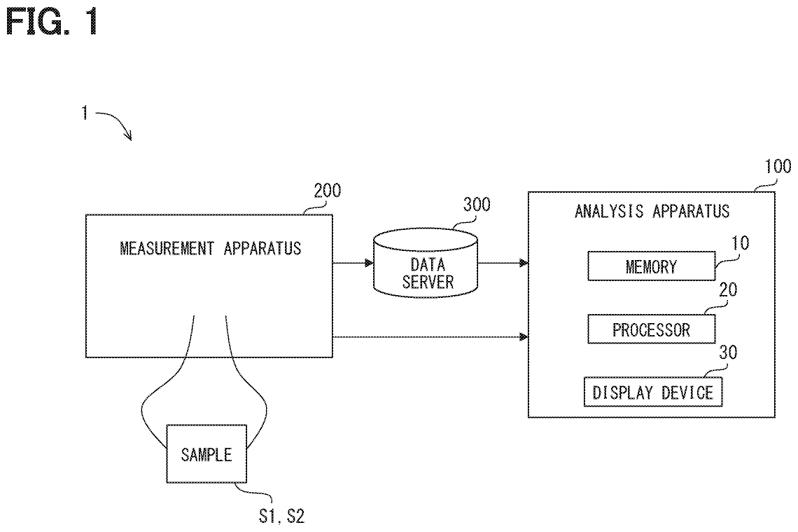

A system 1 shown in FIG. 1 is a system for analyzing electromagnetic noise performance of a product such as an electrical product or an electronic product. The analysis here may include prediction of the electromagnetic noise performance of the product. The analysis here may include sample extraction. The electrical product or electronic product to be analyzed here refers to a product having one or more external power supply points or a product having one or more internal power sources, and may widely encompass, for example, automobiles, automotive parts, home appliances, industrial products, agricultural products, and semiconductor products such as integrated circuits and various sensors using the same.

Electrical products or electronic products including automotive parts are required to have sufficient electromagnetic noise performance as one of required specifications regarding quality. That is, it is required in performance that emitting electromagnetic noise from the product itself (emission performance, EMI: Electro Magnetic Interference) is sufficiently small, and tolerance of not malfunctioning due to electromagnetic noise entering from the outside (immunity performance, EMS: Electro Magnetic Susceptibility) is sufficiently large.

The electromagnetic noise performance of these electrical products or electronic products is determined by complex interaction of multiple factors such as, for example, circuit configuration, materials used, and shape of a housing. Therefore, product design for ensuring electromagnetic noise performance is highly challenging, and it is difficult to predict electromagnetic noise performance. For this reason, when it is confirmed that the electromagnetic noise performance of the electrical product or electronic product does not meet the requirements, a large amount of development man-hours such as redesigning may occur.

In addition, it is typical that the immunity performance often ultimately leads to malfunction of a semiconductor integrated circuit. With respect to electromagnetic noise entering from the outside, multiple circuit blocks in the integrated circuit affect each other and the bottle neck is at the weakest circuit block. However, it takes a large amount of man-hours to specify which circuit block operation caused the malfunction, that is, the malfunction mechanism.

Generally, the electromagnetic noise performance is evaluated in accordance with an evaluation method defined by international standards or the like according to the use of the electrical product or electronic product. For example, the ISO 11452 series applied to automotive parts requires confirmation of immunity performance in accordance with a predetermined evaluation method in a very wide frequency band of 0.01 MHz to 18 GHz. If the injected frequency range changes significantly, the malfunction mechanism also changes correspondingly, leading to further enlargement of development man-hours.

Regarding the automotive parts, the number of evaluation samples for electromagnetic noise performance is often set to one according to commercial customs. The present disclosure includes acquiring “variation in electromagnetic noise performance” by daringly setting the number of first samples (S1) to two or more, or by performing evaluation on one or more samples under different conditions, and focusing on its relationship with “variation in multiple product characteristic values” of the first samples, and introducing a statistical analysis method that has not been applied to this technical field. This method facilitates analyzing a relationship between the electromagnetic noise performance and the product characteristic values by a mathematical method, reducing man-hours required for malfunction mechanism analysis and countermeasures thereof.

This system 1 provides an effective analysis method for reducing development man-hours by specifying a cause of malfunction. The system 1 may be configured to include a measurement apparatus 200, a data server 300, and an analysis apparatus 100.

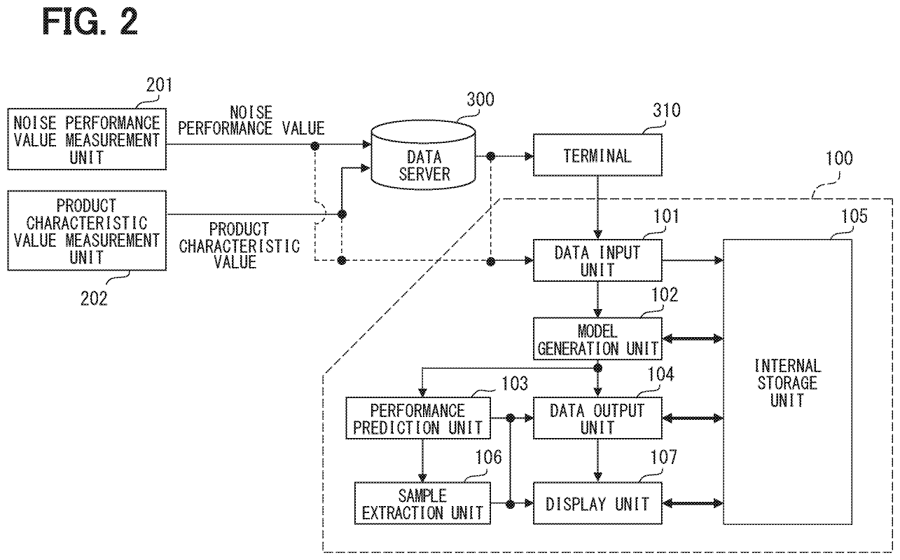

The measurement apparatus 200 is configured to be capable of electrically connecting a product. The measurement apparatus 200 is configured to be capable of measuring the electrically connected product. As shown in FIG. 2, the measurement apparatus 200 may be configured to include a noise performance value measurement unit 201 and a product characteristic value measurement unit 202.

The noise performance value measurement unit 201 is configured to actually measure the electromagnetic noise performance of the product and output a noise performance value based on the actual measurement to the outside of the measurement apparatus 200. Although details will be described later, the noise performance value may be the actually measured value of the electromagnetic noise performance itself, a calculated value calculated based on the actually measured value, a calculated value by simulation, or the like. When the calculated value by simulation is adopted, the measurement apparatus 200 or the noise performance value measurement unit 201 may be replaced with a simulation apparatus that executes simulation. The noise performance value measurement unit 201 may output the noise performance value to the data server 300 or may output it directly to the analysis apparatus 100.

The product characteristic value measurement unit 202 is configured to measure a product characteristic value of the product and output the product characteristic value to the outside of the measurement apparatus 200. Although details will be described later, the product characteristic value may be an actually measured value itself of a current value or a voltage value measured from the product, a calculated value calculated based on the actually measured value, a calculated value by simulation, or the like. When the calculated value by simulation is adopted, the measurement apparatus 200 or the product characteristic value measurement unit 202 may be replaced with a simulation apparatus that executes simulation. The simulation may be, for example, a Monte Carlo simulation in which manufacturing variation is taken into account based on circuit design information. The product characteristic value measurement unit 202 may output the product characteristic value to the data server 300 or may output it directly to the analysis apparatus 100.

The data server 300 is mainly configured by a storage medium and a computer that controls the storage medium. The data server 300 accumulates data measured by the measurement apparatus 200. The data server 300 may be communicably connected to the measurement apparatus 200 by wired communication or wireless communication, or may be configured to sequentially acquire data from the measurement apparatus 200 without user operation. The data server 300 may store an ID of an individual sample of the measured product in association with the noise performance value and the product characteristic value.

Further, the data server 300 may be communicably connected to the analysis apparatus 100 by wired communication or wireless communication. The data server 300 may output the noise performance value and the product characteristic value to the analysis apparatus 100. At this time, the ID of the individual sample may be outputted together. The data server 300 may output the noise performance value and the product characteristic value for each sample of the product, or may collectively output the noise performance values and the product characteristic values of multiple samples.

Further, a user of the system 1 may save the noise performance value and the product characteristic value accumulated in the data server 300 to a terminal 310 including a storage medium such as a USB memory, connect the terminal 310 to the analysis apparatus 100, and cause the analysis apparatus 100 to input the noise performance value and the product characteristic value.

### <Configuration of Analysis Apparatus>.

The analysis apparatus 100 is mainly configured by a computer, and has at least one memory 10 and at least one processor 20. The memory 10 may be a non-transitory tangible storage medium which non-temporarily stores computer programs and data readable by the processor 20 and may be of at least one type among such non-volatile storage media as semiconductor memories like flash memories, magnetic media like hard disk drives (HDD), and optical media. Further, a rewritable volatile storage medium such as a RAM (Random Access Memory) may be provided as the memory 10. The computer program may be an analysis program for analyzing electromagnetic noise performance. The processor 20 includes at least one type among, for example, a CPU (Central Processing Unit), a GPU (Graphics Processing Unit), and a RISC (Reduced Instruction Set Computer)-CPU as a core.

In the analysis apparatus 100, the computer may be configured by installing the analysis program in a personal computer having a general-purpose operating system, or may be a dedicated apparatus specialized for analysis.

The analysis apparatus 100 may include a data input unit 101, a model generation unit 102, a performance prediction unit 103, a data output unit 104, an internal storage unit 105, a sample extraction unit 106, and a display unit 107 as processing units implemented by the processor 20 executing the analysis program to provide functions.

The noise performance value and the product characteristic value are inputted to the data input unit 101. Here, as described above, the noise performance value may be an actually measured value of electromagnetic noise performance or a calculated value of electromagnetic noise performance. Here, the electromagnetic noise performance may be noise performance related to Electro Magnetic Compatibility. The electromagnetic noise performance includes, for example, electromagnetic emission performance and electromagnetic immunity performance, and may also include malfunction tolerance performance in an electrostatic discharge test. The electromagnetic immunity performance may be a malfunction tolerance value against electromagnetic noise obtained under evaluation in accordance with an evaluation method such as an international standard.

Further, the actually measured value of the electromagnetic noise performance may be a value obtained by evaluating the aforementioned electromagnetic noise performance by actual measurement in accordance with one test method defined in an international standard or the like.

Examples of the test method according to the international standard include the IEC 61967 series (Integrated circuits-Measurement of electromagnetic emissions), the IEC 62132 series (Integrated circuits-Measurement of electromagnetic immunity), CISPR 25 (Vehicles, boats and internal combustion engines-Radio disturbance characteristics-Limits and methods of measurement for the protection of on-board receivers), the ISO 11451 series (Road vehicles-Vehicle test methods for electrical disturbances from narrowband radiated electromagnetic energy), the ISO 11452 series (Road vehicles-Component test methods for electrical disturbances from narrowband radiated electromagnetic energy), CISPR 32 (Electromagnetic compatibility of multimedia equipment-Emission requirements), CISPR 35 (Electromagnetic compatibility of multimedia equipment-Immunity requirements), ANSI C63.4 (American National Standard for Methods of Measurement of Radio-Noise Emissions from Low-Voltage Electrical and Electronic Equipment in the Range of 9 kHz to 40 GHz), an evaluation method defined in IEC 61000, an evaluation method applying or citing them mutatis mutandis, or a similar test evaluation method in which a part of the test is changed.

The calculated value of the electromagnetic noise performance may be, for example, a result obtained by modeling an internal integrated circuit as an equivalent circuit and calculating an electromagnetic noise performance value by simulation using a computer or the like. The calculated value of the electromagnetic noise performance may be a result of simulating including modeling the integrated circuit as an equivalent circuit. The calculated value of the electromagnetic noise performance may be a result of simulating a model including a test setup defined in the aforementioned international standard or the like.

The product characteristic value may be, for example, an evaluation result of various inspections such as a wafer acceptance test (WAT) in a manufacturing process. The product characteristic value is a result of evaluation regardless of whether it is included in inspection in a normal process, and may be an evaluation result of circuit characteristics of an electrical product or an electronic product. The evaluation result of the circuit characteristic value may include at least one type among an oscillation frequency, an output value of an ADC (Analog Digital Convertor) or a DAC (Digital Analog Convertor), an output value of an amplifier circuit, a gain of the amplifier circuit, an output value of a constant voltage or constant current source circuit, output values of various digital circuits, various resistance values, various capacitance values, an output value of a filter circuit including an electromagnetic noise filter, and the like. The product characteristic value may be an inspection predictive value of a manufacturing process, a circuit characteristic, or the like calculated by simulating manufacturing variation using a computer or the like.

The model generation unit 102 generates a model for predicting electromagnetic noise performance based on the noise performance value and the product characteristic value. Hereinafter, a method of generating a model will be described using multiple regression analysis as an example, but the method is not limited to multiple regression analysis, and machine learning techniques including simple regression analysis, Bayesian linear regression, Gaussian process regression, neural networks, or the like may be used.

When the multiple regression analysis is used, for example, a regression equation as shown in Formula (A) is established.

$$Y = a 0 + a 1 X 1 + a 2 X 2 + … + anXn , \qquad ( A )$$

where an is a regression coefficient, X is an explanatory variable, Y is a response variable, n is the number of explanatory variables used.

Here, the response variable is the noise performance value, and the explanatory variable is the product characteristic value. Note that for the response variable and the explanatory variable, converted values obtained by converting respective values may be adopted as calculated values based on actual measurement. Examples of conversion include logarithmic conversion, exponential conversion, power, root acquisition, and the like. This is because, depending on malfunction mechanism, a regression model using converted values can be expected to improve the accuracy of electromagnetic noise performance prediction. For example, if values are converted so that a variation of multiple samples is close to a normal distribution, a model with high prediction accuracy can be generated. The conversion process in the case of using the converted values may be performed in advance by the measurement apparatus 200, the data server 300, the data input unit 101, or the like other than the model generation unit 102.

The explanatory variables used for the regression model and the number n thereof are optionally given. When there are many explanatory variables, it is also possible to determine the priorities of explanatory variables by using a variance ratio of the response variable and the explanatory variable, a residual sum of squares, or the like. Further, the number of explanatory variables can be determined based on a certain R2 score, or can be determined using an evaluation function or the like. As an example of the evaluation function, it is assumed that Akaike Information Criterion (AIC), Bayesian Information Criterion (BIC), or the like is used. Thus, it is possible to improve the generative model by comparing the already generated model with the newly generated model.

The performance prediction unit 103 extracts item names of product characteristic values corresponding to one or more response variables used in the model generation by the model generation unit 102. Further, the performance prediction unit 103 calculates a predictive value of the electromagnetic noise performance using the generative model generated by the model generation unit 102.

Here, the performance prediction unit 103 may calculate a predictive value of the electromagnetic noise performance for a product characteristic value of a sample (referred to as a first sample S1) of which electromagnetic noise performance is known, and which was used in the model generation by the model generation unit 102. When the product characteristic value of the first sample S1 is used, the predictive value of the electromagnetic noise performance can be used for confirming whether the generated model is normal or whether the generated model has expected prediction accuracy.

Further, the performance prediction unit 103 may calculate a predictive value of the electromagnetic noise performance for a product characteristic value of a sample (second sample S2) which is different from the first sample S1 and of which electromagnetic noise performance is unknown. When the product characteristic value of the second sample S2 is used, the predictive value of the electromagnetic noise performance can be used for product verification and development.

The data output unit 104 outputs data in an externally usable format. The data may include the generative model itself. The data may include all or part of names of one or more product characteristic values used in the model generation and predictive values of electromagnetic noise performance, and may include graphs visualizing them. The externally usable format may be, for example, a table data format such as csv or xlsx, an image data format such as png, or a document data format such as word, pptx, or pdf. Note that an output unit may be defined as a processing unit into which both the performance prediction unit 103 and the data output unit 104 are combined.

The internal storage unit 105 stores various variable values in the memory 10 and performs input/output with respect to each unit. Specifically, the variable values are the inputted noise performance value and product characteristic value, the response variable, the explanatory variable, a list of response variables to be used, the generation model, a calculated value of the evaluation function, the predictive value of the electromagnetic noise performance, and the like. These variable values may be referred to as data related to analysis of electromagnetic noise performance. The internal storage unit 105 may store data related to analysis of electromagnetic noise performance for a large number of samples acquired by the data input unit 101, wherein the samples are to be extracted by the sample extraction unit 106 described later.

With respect to a condition optionally given, the sample extraction unit 106 has a functionality of extracting a sample of an electrical product or an electronic product having an electromagnetic noise performance value satisfying the condition. For example, when a condition regarding a predictive value such as a predictive value or a range of a predictive value is given by a user's operation to the analysis apparatus 100, the sample extraction unit 106 can extract one or more samples matching the condition by comparing the condition regarding the predictive value with the predictive value calculated by the performance prediction unit 103. Further, for example, when a condition regarding actual measurement such as a noise performance value or a range of a noise performance value which is an input value is given by a user's operation to the analysis apparatus 100, the sample extraction unit 106 can extract one or more samples matching the condition by comparing the condition regarding the actual measurement with the predictive value calculated by the performance prediction unit 103. The sample extraction unit 106 may have a function of extracting a sample satisfying a condition such as a sample at a median, a mode, an average value in a histogram of the product characteristic values extracted by the performance prediction unit 103 or samples within a standard deviation from the average value. Furthermore, when a product characteristic value of main interest is already known from design information of an electrical product or an electronic product, or a series of model generation and analysis described above for the same or similar electrical product or electronic product, a sample having electromagnetic noise performance satisfying a condition regarding the product characteristic value may be extracted from among samples stored in the memory 10 without performing the series of model generation described above. By doing so, sample extraction can be performed without newly acquiring multiple noise performance values of samples, leading to further reduction in development man-hours. When multiple performance characteristic values are extracted, extraction of samples corresponding to respective product characteristic values may be performed.

The display unit 107 displays display target data regarding the analysis process for electromagnetic noise performance by using the display device 30. The display target data is a part of data processed by the data input unit 101, the model generation unit 102, the performance prediction unit 103, the data output unit 104, and the sample extraction unit 106.

### <Process by Analysis Apparatus>.

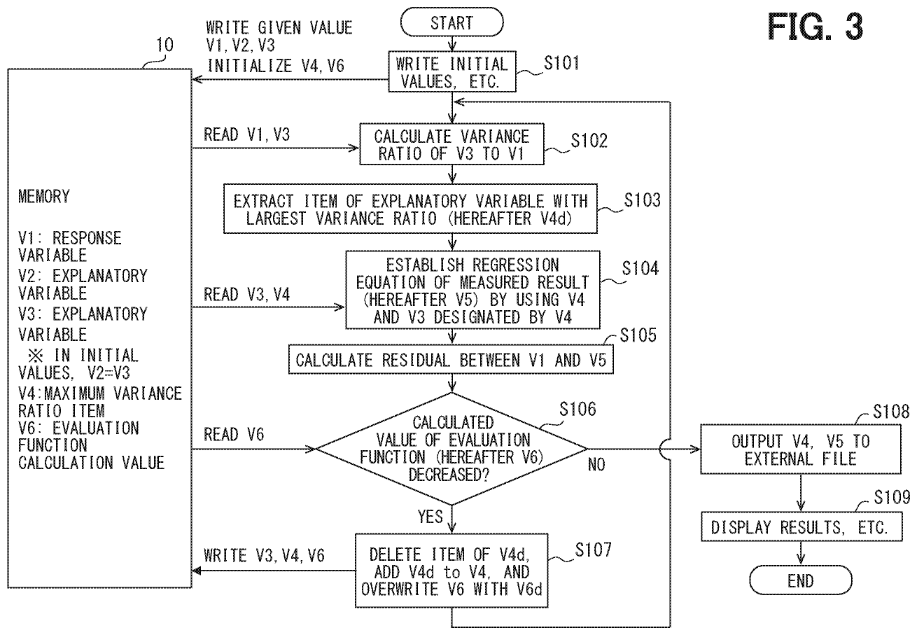

Hereinafter, an example of a process by an analysis method using multiple regression analysis focusing on a variance ratio and a regression residual will be described using the flowcharts of FIGS. 3 to 5. This process may be executed by the processor 20 of the analysis apparatus 100 executing the analysis program stored in the memory 10.

First, FIG. 3 shows a process of extracting a specific explanatory variable from multiple explanatory variables and outputting the extracted explanatory variable or a generative model thereof.

In S101, the data input unit 101 writes the inputted noise characteristic value of the first sample S1 into the memory 10 as the response variable V1. The data input unit 101 writes the inputted product characteristic values of the first sample S1 into the memory 10 as explanatory variables V2 and V3 in the memory 10. Here, in the initial values, V2 and V3 are set to the same value. Further, the data input unit 101 initializes the top item V4 of the variance ratio and the calculated value V6 of the evaluation function. After S101, the process proceeds to S102.

In S102, the model generation unit 102 reads the response variable V1 and the explanatory variable V3 from the memory 10, and calculates a variance ratio of the explanatory variable V3 to the response variable V1. After the process of S102, the process proceeds to S103.

In S103, the model generation unit 102 extracts an item having the largest variance ratio (hereinafter referred to as V4d) from the variance ratios calculated in S102. After the process of S103, the process proceeds to S104.

In S104, the model generation unit 102 establishes a regression equation V5 as a generative model capable of predicting electromagnetic noise performance, by using V4d and the explanatory variable V3 specified by V4 stored in the memory 10. That is, each regression coefficient of the regression equation V5 is set. After the process of S104, the process proceeds to S105.

In S105, the model generation unit 102 calculates a difference between the response variable V1 and the regression equation V5, that is, a regression residual. After the process of S105, the process proceeds to S106.

In S106, the model generation unit 102 evaluates the regression residual calculated in S105 by the aforementioned evaluation function. The model generation unit 102 determines whether or not the calculated value V6d of the evaluation function based on the regression residual this time is smaller than the calculated value V6 of the evaluation function stored in the memory 10. If Yes, the process proceeds to S107 to improve the model. If No, the model generation unit 102 determines that further improvement of the model is unnecessary, and the process proceeds to S108.

In S107, the model generation unit 102 deletes the item V4d of the explanatory variable having the largest variance ratio from the explanatory variables V3 stored in the memory 10. Further, the model generation unit 102 adds V4d to V4 stored in the memory 10. Then, the model generation unit 102 overwrites the calculated value V6 of the evaluation function stored in the memory 10 with V6d calculated in S106. After the process of S107, the process returns to S102. That is, the result of the current model generation is reflected in the next model improvement, and the process is continued.

In S108, the data output unit 104 outputs the top item V4 of the variance ratio and the regression equation V5 established in the latest process of S104 to an external file. In S109 after the process of S108, the display unit 107 displays numerical values, results, and the like (for example, an external file) used in the process on the screen of the display device 30, and ends the process.

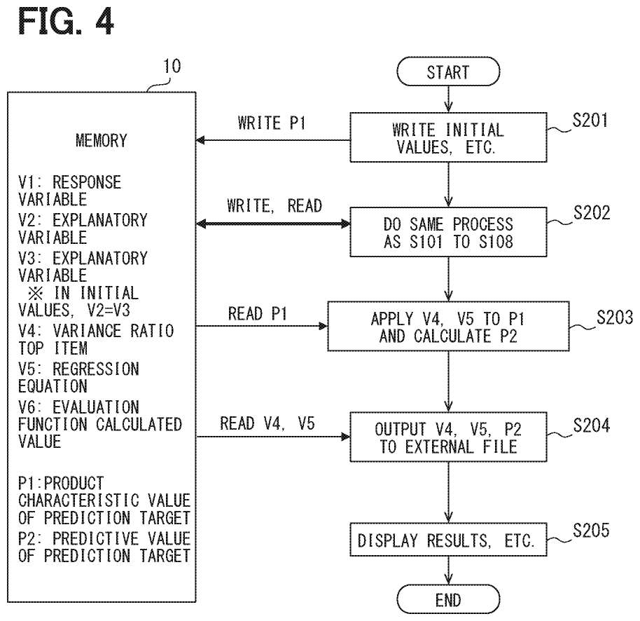

FIG. 4 shows a process for predicting electromagnetic noise performance including the processes of S101 to S108.

In S201, the data input unit 101 writes a product characteristic value P1 of a prediction target product into the memory 10. As described above, the prediction target product may be the first sample S1 used in the model generation (S101 to S108), or may be the second sample S2 different from the first sample S1. After the process of S201, the process proceeds to S202.

S202 is a model generation process similar to S101 to S108. However, in S108, the top item V4 of the variance ratio and the regression equation V5 are written into the memory 10 for subsequent processing. After the process of S202, the process proceeds to S203.

In S203, the performance prediction unit 103 applies the top item V4 of the variance ratio and the regression equation V5 outputted in S202 to the product characteristic value P1, and calculates a predictive value P2 of the electromagnetic noise performance of the prediction target product. After the process of S203, the process proceeds to S204.

In S204, the data output unit 104 outputs the top item V4 of the variance ratio, the regression equation V5, and the predictive value P2 to an external file as data related to analysis. In S205 after the process of S204, the display unit 107 displays numerical values, results, and the like (for example, an external file) used in the process on the screen of the display device 30, and ends the process. Note that the order of the process of S201 and the process of S202 may be interchanged.

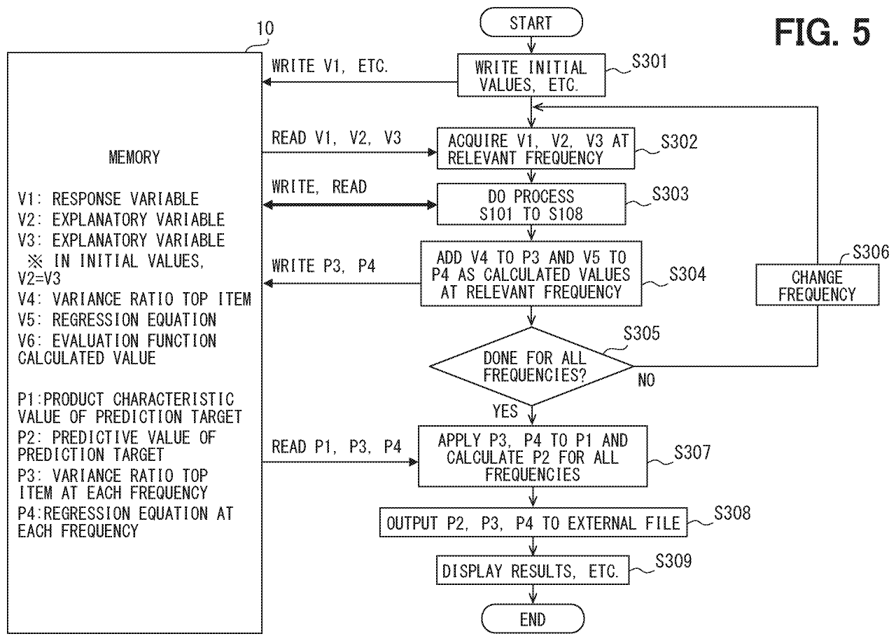

Although the model generation process and the electromagnetic noise performance prediction process for one frequency have been described in the flowcharts of FIGS. 3 and 4 (S101 to S108, S201 to S205), the entire process for multiple frequencies, that is, the entire analysis process, will be described in the flowchart of FIG. 5 (S301 to S309).

In S301, V1 to V6 are written as initial values into the memory 10 by the data input unit 101 similarly to S101 and S201. Here, variables such as explanatory variables V2 and V3 need to be prepared for each frequency to be analyzed. In S301, the product characteristic value of the first sample S1 is used. After the process of S301, the process proceeds to S302.

S302 to S304 are processes for one frequency. In S302, the model generation unit 102 reads the response variable V1 and the explanatory variables V2 and V3 at the frequency under analysis from the memory 10. After the process of S302, the process proceeds to S303.

In S303, the model generation unit 102 executes a model generation process similar to S101 to S108 for the frequency under analysis by using the variables V1 and V2 read in S302. After the process of S303, the process proceeds to S304.

In S304, the model generation unit 102 adds the top item V4 of the variance ratio as a calculated value of the frequency under analysis to a top item P3 of the variance ratio at each frequency, and adds the regression equation V5 to a regression equation P4 at each frequency. After the process of S304, the process proceeds to S305.

In S305, the model generation unit 102 determines whether or not model generation has been completed for all frequencies scheduled for analysis. If No, the process proceeds to S306. If Yes, the model generation for each frequency is ended, and the process proceeds to S307.

In S306, the model generation unit 102 changes the frequency. After the process of S306, the process returns to S302 to perform the processes of S302 to S304 for the next frequency.

In S307, the performance prediction unit 103 applies the top item P3 of the variance ratio and the regression equation P4 to the product characteristic value P1 of the prediction target product, and calculates the predictive value P2 of the prediction target product for all frequencies. The prediction target product may be the first sample S1 or the second sample S2 similarly to S201. After the process of S307, the process proceeds to S308.

In S308, the data output unit 104 outputs the predictive value P2, the top item P3 of the variance ratio, and the regression equation P4 to an external file as data related to analysis. In S309 after the process of S308, the display unit 107 displays numerical values, results, and the like (for example, an external file) used in the process on the screen of the display device 30, and ends the process.

As described above, in order to predict the electromagnetic noise performance, the actual measured value or calculated value of the electromagnetic noise performance measurement on the electrical product or electronic product, and the variation data of the product characteristic values are used.

An example of the product characteristic value is a circuit characteristic measurement value for each individual product for the purpose of improving yield and excluding products with abnormal performance in manufacturing electrical products or electronic products. Since these are measurements necessary for product manufacturing, they are available at low cost regardless of the implementation of the present disclosure. WAT is known as an example of the measurement in semiconductor circuit manufacturing.

Since these test items are generally measurements in a steady state, basic circuit characteristics can be confirmed, but electromagnetic noise performance having frequency information is not directly measured. The present embodiment is based on founding that electromagnetic noise having frequency information can be estimated by using results obtained by measuring basic data of these circuit characteristics with a large number of samples and analyzing the variation thereof. By using this technique, it becomes possible to predict electromagnetic noise performance without requiring construction of a physical model necessary for predicting electromagnetic noise performance. Furthermore, if basic characteristics of a circuit serving as a main factor of electromagnetic noise performance is successfully specified from statistical analysis or the like, design support such as changing a design policy of the circuit portion is implementable.

According to the first embodiment described above, a model is generated using the first sample S1, and a predictive value related to the electromagnetic noise performance of the second sample S2 is calculated using the generated model. That is, the electromagnetic noise performance of the second sample S2 different from the first sample S1 is easily predictable from information of the first sample S1.

Here, the generated model is a model having the noise performance value of the electromagnetic noise performance as the response variable and having the product characteristic values of the first sample S1 as the explanatory variables. By inputting the product characteristic values of the second sample S2 to this model in place of the first sample S1, a predictive value is obtained. That is, by analyzing basic characteristics that determine the electromagnetic noise performance of the second sample S2, a cause of a malfunction can be easily specified. As a result, an increase in man-hours required for analysis of the product can be reduced or prevented.

Further, according to the first embodiment, a model is generated using the first sample S1, and a predictive value related to the electromagnetic noise performance is calculated by inputting the product characteristic values of the first sample S1 to the generated model. Thus, it is possible to easily verify whether the prediction of the generated model is abnormal. As a result, an increase in man-hours required for analysis of the product can be reduced or prevented.

Further, according to the first embodiment, the product characteristic value includes a circuit characteristic value of a circuit included in the sample. Since the circuit characteristic value is used as the explanatory variable, a cause of a malfunction can be easily specified by analyzing a cause related to the circuit characteristic value in question.

Further, according to the first embodiment, the variance ratio and/or the residual sum of squares of the product characteristic value to the noise performance value is calculated, and a regression equation of the electromagnetic noise performance is generated using the variance ratio and/or the residual sum of squares. Variation between samples can be reflected in the regression equation.

Further, according to the first embodiment, the model is improved by comparing the already generated model with the newly generated model. By improving the model, the prediction accuracy of the electromagnetic noise performance can be improved.

Further, according to the first embodiment, individual models are generated for multiple frequencies, and predictive values of electromagnetic noise performance are calculated for the multiple frequencies by using the models generated individually for the multiple frequencies. Since the electromagnetic noise performance of multiple frequencies is predicted, a cause of a malfunction can be easily specified.

Further, according to the first embodiment, based on a condition optionally given and a predictive value of electromagnetic noise performance, it is possible to extract a sample having a noise performance value satisfying the condition from among multiple samples which are calculation targets of the predictive value. With this function, it becomes easy to specify a sample to be verified intensively, and an increase in man-hours required for analysis of the product can be reduced or prevented.

Further, the first embodiment is configured such that data related to the analysis process is displayable. By visually recognizing the display, the user can easily conform the analysis result.

### Second Embodiment

The second embodiment is a modification of the first embodiment. The second embodiment will be described focusing on differences from the first embodiment.

A calculation method of a variance ratio and a determination method of an explanatory variable used in Formula (A) which is the regression equation shown in the first embodiment are, for example, as follows. Here, a matrix is prepared in which noise performance values and the like of m samples are set as vertical vectors, and vectors of l product characteristic values corresponding to respective samples are combined in a horizontal direction. For the matrix, a covariance matrix S is as shown in the following Equation 1 where i is an integer satisfying 0≤i≤l, and j is an integer satisfying 0≤j≤l.

$$S = [ \begin{matrix}{S}_{00} & {S}_{10} & … & {S}_{l 0} \\ {S}_{01} & {S}_{11} & … & {S}_{l 1} \\ ⋮ & ⋮ & {S}_{ij} & ⋮ \\ {S}_{0 l} & {S}_{0 l} & … & {S}_{ll}\end{matrix} ] . \qquad 〈 Equation 1 〉$$

Any element Sij in the above satisfies the following Equation 2. Note that Xik represents the k-th element (1≤k≤m) of Xi. Xi with a bar indicates an average of elements in Xi. When i=j, Sii represents variance as shown in Equation 3. Here, Sij=Sji. Si0 or S0j indicates a covariance between the response variable and the i-th or j-th explanatory variable, respectively. In the following formulas, Si0 may be changed to S0j, and other i and j may be interchanged.

$${S}_{i j} = \frac{1}{m} {\sum }_{k = 0}^{m} ( {X}_{i k} - \overline{Xi} ) ( {X}_{j k} - \overline{Xj} ) . \qquad 〈 Equation 2 〉$$

$${S}_{i i} = \frac{1}{m} {\sum }_{k = 0}^{m} {( {X}_{i k} - \overline{Xi} )}^{2} . \qquad 〈 Equation 3 〉$$

Here, SRi and Sei corresponding to the i-th response variable, and Ri which is a variance ratio thereof are defined as in the following Equations 4, 5, 6.

$${SR}_{i} = \frac{{S}_{i 0}^{2}}{{S}_{i i}} . \qquad 〈 Equation 4 〉$$

$${Se}_{i} = {S}_{00} - {SR}_{i} . \qquad 〈 Equation 5 〉$$

$${R}_{i} = \frac{{SR}_{i}}{{Se}_{i}} . \qquad 〈 Equation 6 〉$$

In the above method, by way of example, the covariance matrix shown in Equation 1 is shown for a descriptive purpose. However, the covariance coefficient shown in Equation 2 may be directly calculated for each response variable and each explanatory variable. In that case, the establishment of Equation 1 may be unnecessary. Further, Equation 6 may be obtained by multiplying or dividing various values such as degrees of freedom. Xi with which Ri becomes largest may be added as an explanatory variable used in Formula (A).

Next, a calculation method of a residual sum of squares used in Formula (A) which is the regression equation shown in the first embodiment will be described. A regression equation is prepared in which an n+1-th optionally given explanatory variable Xi is added to n explanatory variables already selected by the aforementioned method of determining the response variable using the variance ratio or by the present method of calculating the residual sum of squares. As shown below, this selection of Xi may be determined by calculating the residual sum of squares for all unselected explanatory variables. Let Y be a predictive value obtained using n explanatory variables using Formula (A), and Ypred be a predictive value obtained similarly to Formula (A) using n+1 explanatory variables in which Xi is further added to the explanatory variables. Then, Sei, VRi and Ri are obtained as in the following Equations 7, 8, 9.

$${Se}_{i} = \frac{1}{m} {\sum }_{k = 0}^{m} {( Y - \overline{Y} )}^{2} - \frac{1}{m} {\sum }_{k = 0}^{m} {( {Y}_{pred} - \overline{{Y}_{pred}} )}^{2} . \qquad 〈 Equation 7 〉$$

$${VR}_{i} = {Se}_{n} - {Se}_{i} . \qquad 〈 Equation 8 〉$$

$${R}_{i} = \frac{{VR}_{i}}{{Se}_{i}} \qquad 〈 Equation 9 〉$$

Here, Sen is a value already defined by Equation 5 or Equation 7 depending on the process of selecting the n-th explanatory variable. In Equation 8, a difference between the aforementioned Sen and Sei when Xi is added as the n+1-th explanatory variable is defined as VRi. Note that Equation 9 may be obtained by multiplying or dividing various values such as degrees of freedom. Xi with which Ri becomes largest may be added as an explanatory variable used in Formula (A). In that case, Sen may be redefined by Equation 7 corresponding to the newly added Xi, and used for determining the n+2-th explanatory variable. Note that Equation 1 to Equation 9 described above may be paraphrased as Formula 1 to Formula 9.

### Third Embodiment

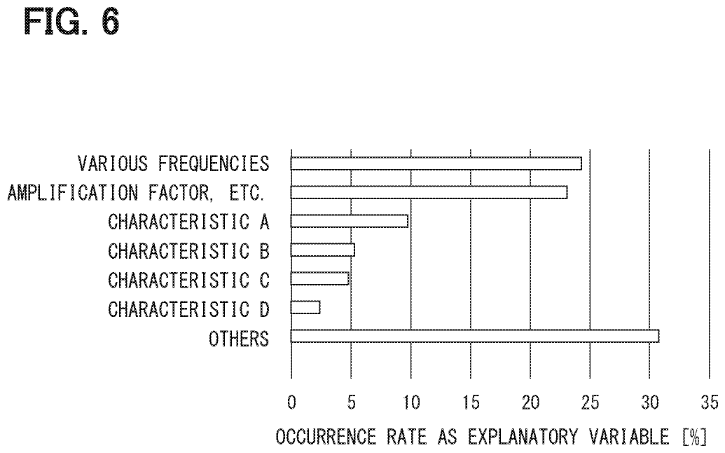

As shown in FIGS. 6 to 13, the third embodiment is a modification of the first embodiment. The third embodiment will be described focusing on differences from the first embodiment.

The third embodiment is directed to an analog sensor product having a differential amplifier circuit, and traveling wave power at the time of malfunction obtained by the IEC 62132-4 DPI method is used as a response variable, and an evaluation result of WAT is used as an explanatory variable. FIG. 6 shows appearance rates when the top three explanatory variables obtained by analysis of the variance ratio and the residual sum of squares at each frequency are grouped by evaluation item of WAT. From these results, it can be seen that in the target product, the evaluation items of WAT related to various frequencies and the evaluation items of WAT related to the amplification factor have a high contribution to the immunity performance. Thus, a cause such as a malfunction source or a malfunction mechanism can be estimated by analysis of the evaluation result alone, and the man-hours required for analysis of the product can be significantly reduced.

Using the oscillation frequency and the amplitude amplification factor as representatives of the evaluation items of WAT having a high contribution described above, samples matching an optionally-given condition can be automatically selected. Examples of extracted samples are shown in Table 1.

TABLE 1

| | Sample Name | | | | |
|---|---|---|---|---|---|
| | A1 | A2 | A3 | B1 | C1 |
| Oscillation | Representative Value | | | Representative | Representative |
| Frequency | | | | Value + 1% | Value − 1% |
| Amplitude | Representative | Representative | Representative | Representative | |
| Amplification | Value | Value × 0.9 | Value × 1.1 | Value | |
| Factor | | | | | |

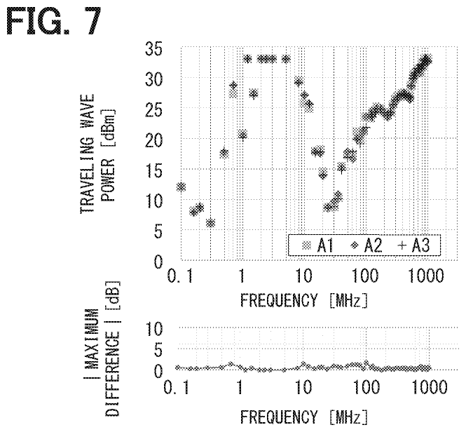

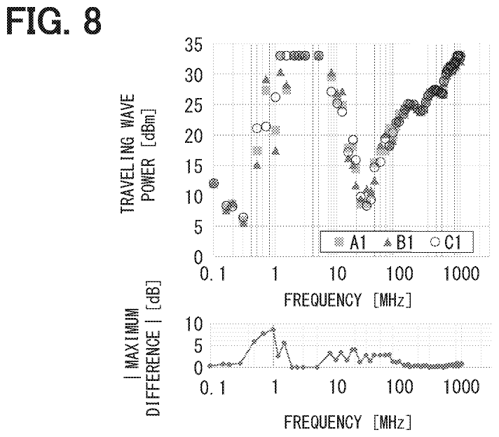

The results of evaluating these samples by the IEC 62132-4 DPI method are shown in FIGS. 7 and 8. In sample groups A1, A2, and A3 having the same oscillation frequency and different amplitude amplification factors, the maximum difference between each sample is about 2 dB. On the other hand, in sample groups A1, B1, and C1 having the same amplitude amplification factor and different oscillation frequencies, there is a difference of about 8 dB. From this, it can be seen that the immunity performance is greatly affected by the oscillation frequency. From the above, it is shown that by performing the proposed analysis of electromagnetic noise performance, design items contributing to malfunction are estimated to be the oscillation frequency and the amplitude amplification factor, and appropriate evaluation samples can be selected.

In order to perform these analyses, it is necessary to acquire product characteristic values for multiple samples. These product characteristic values may be obtained by measuring each characteristic value of the product.

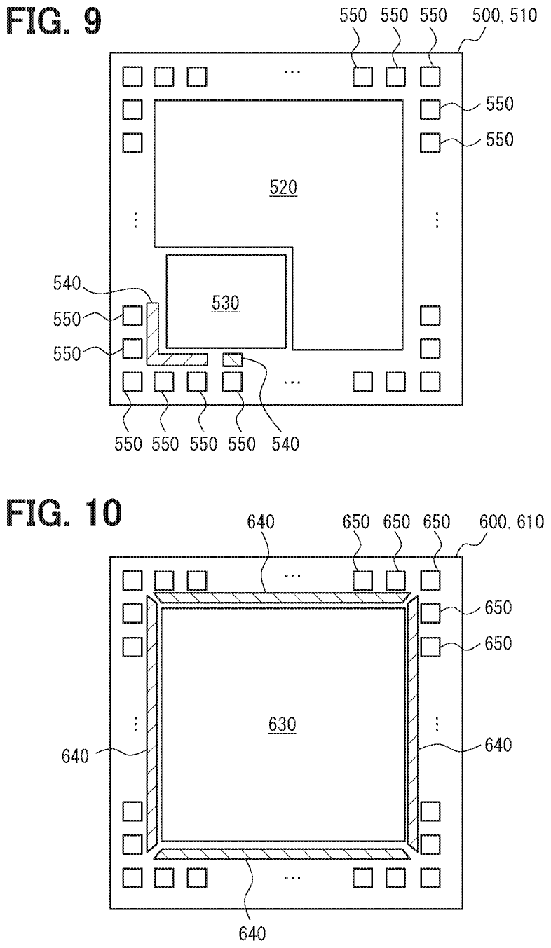

Further, in order to perform analysis more easily or effectively, a semiconductor device as a sample may be configured as shown in FIG. 9. A semiconductor device 500 in FIG. 9 is configured in a chip shape having a rectangular outer peripheral contour provided by cutting a portion corresponding to a die (Die) of a semiconductor wafer.

The semiconductor device 500 includes a substrate 510, a product circuit 520, a measurement circuit 530, an output switching circuit 540, and multiple pads (PAD) 550. The substrate 510 is formed in a plate shape using silicon or the like as a main material. The product circuit 520 and the measurement circuit 530 are arranged so as to divide a region in the center of the semiconductor device 500, and coexist on the same chip. The product circuit 520 is a circuit for exhibiting a functionality of a product, which is collectively mounted in a block shape on the substrate 510. The product circuit 520 is configured by combining multiple types of electronic components according to its function.

The measurement circuit 530 is a circuit for measuring a product characteristic value and is collectively mounted in a block shape on the substrate 510 so as to be separated from a region of the product circuit 520. The measurement circuit 530 is provided by electronic components only and the number of electronic components is fewer than the product circuit for only measuring the product characteristic value. For example, the measurement circuit 530 may be provided by only an oscillation circuit used for measurement. For example, the measurement circuit 530 may be used as a so-called TEG (test element group).

The measurement circuit 530 may be capable of measuring multiple types of product characteristic values. For example, the measurement circuit 530 measures measurement values related to time such as an oscillation frequency, frequencies of various control signals generated from the oscillation frequency, its oscillation frequency, and pulse widths of various control signals, output values of an ADC and a DAC, an output value of an amplifier circuit, a gain of the amplifier circuit, an output value of a constant voltage or constant current source circuit, output values of various digital circuits, various resistance values, various capacitance values, an output value of a filter circuit including an electromagnetic noise filter, and the like, and may be capable of measuring one type or multiple types of product measurement values among them.

The multiple pads 550 are input/output terminals arranged so as to surround the entire periphery of the outer peripheral portion of the semiconductor device 500. The multiple pads 550 may be divided into pads dedicated to the product circuit 520 and pads dedicated to the measurement circuit 530. On the other hand, at least part of the pads 550 may be shared between the product circuit 520 and the measurement circuit 530. For the measurement circuit 530, each pad 550 functions as an output terminal that outputs a measurement result of the product characteristic value.

The output switching circuit 540 is arranged separately from the measurement circuit 530, for example, is arranged in a region between the measurement circuit 530 and the pad 550 functioning as an output terminal of the measurement result, and is a circuit that switches the type of the product characteristic value outputted to the pad 550. The output switching circuit 540 may be configured using, for example, an analog switch, a multiplexer, or the like. Due to the presence of such an output switching circuit 540, many types of product characteristic values can be measured without measuring a large number of pads 550. In other words, evaluation time can be reduced by reducing probe movement time for changing the pad 550 to be connected during measurement. Note that the output switching circuit 540 may be integrated with the measurement circuit 530 without the region separation.

Further, as shown in FIG. 10, a semiconductor device 600 may be configured. The semiconductor device 600 includes a substrate 610, a measurement circuit 630, an output switching circuit 640, and multiple pads 650. That is, the example of FIG. 10 differs from the example of FIG. 9 in that the product circuit is not mounted and it is dedicated to measurement. The measurement circuit 630 has the same function as the example of FIG. 9, but can be mounted on the entire region of the center of the semiconductor device 600. Thereby, many types of product characteristic values may be measurable. The output switching circuit 640 is arranged so as to surround the entire circumference of the measurement circuit 630 in order to correspond to the higher performance measurement circuit 630, and may be capable of switching between many types of product characteristic values.

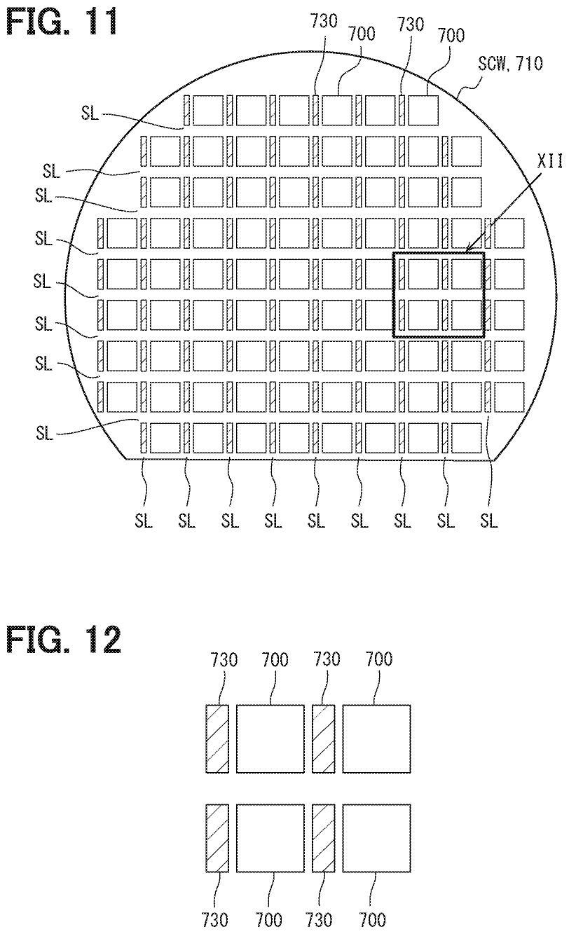

On the other hand, as shown in FIG. 11, a semiconductor wafer SCW may be configured such that the measurement circuit is not arranged inside of the semiconductor device but a measurement circuit 730 is arranged outside. The semiconductor wafer SCW includes a substrate 710, multiple dies 700, and multiple measurement circuits 730. The substrate 710 has a partially circular outer peripheral contour including a flat zone extending linearly, and is formed in a flat plate shape using silicon or the like as a main material. Note that the semiconductor wafer SCW may have a notch instead of the flat zone.

Cutting into a chip shape in units of die 700 is performed in a subsequent process. Each die 700 is configured such that a product circuit can be mounted therein. The multiple dies are arranged in a two-dimensional lattice shape so as to be spaced apart from each other with a region called a scribe line SL therebetween. The arrangement direction of the multiple dies 700 may be a substantially vertical direction and a substantially horizontal direction with respect to the extending direction of the flat zone, or may be an oblique direction forming an acute angle or an obtuse angle with respect to the extending direction.

The multiple measurement circuits 730 are circuits for measuring product characteristic values, similarly to the measurement circuits 530 and 630 in FIGS. 9 and 10. The multiple measurement circuits 730 are arranged in the scribe line SL. With such an arrangement, the area for mounting the product circuit in the die 700 is not restricted. As shown in an enlarged view of FIG. 12, the multiple measurement circuits 730 have respective correspondence relationships with the multiple dies 700. For example, the respective correspondence relationship is a relationship in which the die 700 and the measurement circuit 730 are associated one-to-one. Therefore, the measurement circuits 730 are provided in the same number as the dies 700, and are each arranged so as to be adjacent to one side of the die 700 having the one-to-one correspondence relationship.

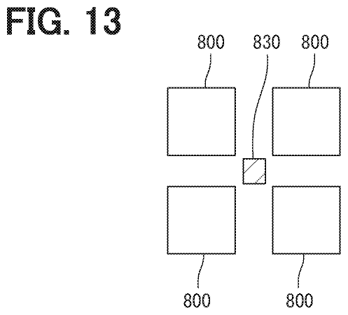

Further, as shown in FIG. 13, the respective correspondence relationship is a relationship in which dies 800 and a measurement circuit 830 are associated multiple-to-one (for example, four-to-one). In the example of FIG. 13, the measurement circuit 830 is arranged so as to be adjacent to a vertex portion of each die 800 so as to be surrounded by four dies 800 arranged in a lattice shape. In this case, the number of measurement circuits 830 may be approximately one-fourth compared to FIG. 12. Note that the respective correspondence relationship may be two-to-one.

Thus, by adopting a configuration in which the measurement circuits 730 and 830 are adjacent to all of the multiple dies 700, 800 on the semiconductor wafer SCW, it is possible to acquire a variation in product characteristic values in each die 700, 800 on the semiconductor wafer SCW. Then, it is expected that analyzing this variation results in an improvement index of the semiconductor process. By such improvement, it is possible to achieve product design in which malfunction or the like is unlikely to occur and it is possible to lead to reduction in man-hours for analysis, countermeasures, and the like.

Further, by performing evaluation and analysis for each manufacturing line of the aforementioned measurement circuits 530, 630, 730, 830 before product design, the measurement circuits 530, 630, 730, 830 can be utilized for noise countermeasure design of product design.

According to the third embodiment described above, the measurement circuits 530, 630 are provided in the semiconductor devices 500, 600, and the measurement result of the product characteristic value can be obtained from the measurement circuits 530, 630 through the pads 550, 650 as output terminals, so that an increase in man-hours required for analysis of the product can be reduced or prevented.

Further, according to the third embodiment, since the measurement result of the product characteristic value can be obtained through the measurement circuits 730, 830 having the respective correspondence relationship with the multiple dies 700, 800, an increase in man-hours required for analysis of the product, including an influence on each die 700, 800 constituting the semiconductor wafer SCW, can be reduced or prevented.

### Other Embodiments

Although multiple embodiments have been described above, the present disclosure is not interpreted as being limited to the embodiments, and can be applied to various embodiments without departing from the spirit and scope of the present disclosure.

In another embodiment, the system 1 may be configured not to include the data server 300 and the terminal 310. Data measured by the measurement apparatus 200 may be accumulated in the memory 10 of the analysis apparatus 100.

In another embodiment, the analysis apparatus 100 may not display numerical values, results, and the like used in processes. In this case, the analysis apparatus 100 may be configured not to include the display device 30. The analysis apparatus 100 may output the analysis result to an external file so that it can be processed and displayed by another apparatus.

In another embodiment, the electromagnetic immunity performance may be a power value leading to a malfunction with respect to electromagnetic noise obtained under evaluation in accordance with an evaluation method such as an international standard, that is, a malfunction tolerance value. The electromagnetic immunity performance may be an output fluctuation amount when predetermined power or the like is applied.

In another embodiment, the actually measured value of the electromagnetic noise performance may be a value obtained by combining evaluations of actual measurement in accordance with multiple types of test methods defined in international standards or the like for electromagnetic noise performance. For example, an analysis combining an evaluation result of conducted emission and an evaluation result of radiated emission, or an analysis combining an evaluation result of conducted immunity and an evaluation result of radiated immunity may be performed. These are effective for estimating a generation/propagation mechanism of emission and estimating a malfunction mechanism of immunity.

In another embodiment, the test method may include a case where different disturbance waves are applied in the same single test system. For example, the test method may include setting a modulation method of a disturbance wave to CW (Continuous Wave) modulation, AM (Amplitude Modulation) modulation, or FM (Frequency Modulation) modulation, and may also include using a noise model such as Additive White Gaussian Noise (AWGN).

Further, the test system may be changed, and evaluation may be performed in different propagation modes of noise. For example, the test method may include injecting the aforementioned various disturbance waves into an evaluation target product in an evaluation system with different propagation modes of a common mode and a differential mode. It is expected that combining these multiple evaluation conditions improves efficiency in estimating the malfunction mechanism of immunity.

In another embodiment, the evaluation result of the circuit characteristic value is a measurement value related to time such as an oscillation frequency, frequencies of various control signals generated from the oscillation frequency, pulse widths of various control signals, rise time and fall time, duty ratios thereof, output values of an ADC and a DAC, an output value of an amplifier circuit, a gain of the amplifier circuit, an output value of a constant voltage or constant current source circuit, output values of various digital circuits, various resistance values, various capacitance values, an output value of a filter circuit including an electromagnetic noise filter, and the like, and may include at least one type among them.

In another embodiment, the predictive value of the electromagnetic noise performance calculated by the performance prediction unit 103 may be utilized as a behavior model of an IC. Specifically, it is expected that the model may be ICIM-CI model (IEC 62433-4) and ICIM-CPI (IEC 62433-6).

In another embodiment, as a condition used in sample extraction by the sample extraction unit 106, a predictive value of electromagnetic noise performance may be used. Further, as the condition, one or multiple explanatory variables which are item names of product characteristic values extracted by the performance prediction unit 103 may be used.

In another embodiment, a range of a predictive value as a condition used in sample extraction by the sample extraction unit 106 may be a range in which a difference between a predictive value of a sample different from a specific sample and an actually measured value or a predictive value of the specific sample is equal to or less than a certain value.

The control units and the methods thereof described in the present disclosure may be implemented by a dedicated computer provided by configuring a processor programmed to execute one or multiple functions embodied by a computer program. Alternatively, the apparatuses and the methods thereof described in the present disclosure may be implemented by a dedicated hardware logic circuit. Alternatively, the apparatuses and the methods thereof described in the present disclosure may be implemented by one or more dedicated computers provided by configuring a processor that executes a computer program in combination with one or more hardware logic circuits. Further, the computer program may be stored in a computer-readable non-transitory tangible storage medium as instructions executed by a computer.

What is claimed is:

1. An analysis apparatus configured to execute an analysis process for electromagnetic noise performance of a sample, comprising:
at least one processor that executes a program stored in a storage medium and/or at least one dedicated circuit, implementing:
a model generation unit configured to generate a model having a noise performance value of the electromagnetic noise performance of a first sample as a response variable and having a plurality of product characteristic values of the first sample as explanatory variables; and
an output unit configured to input a plurality of product characteristic values of a second sample different from the first sample to the explanatory variables of the model, and configured to output data related to analysis of the electromagnetic noise performance of the second sample by using the model, wherein the plurality of product characteristic values of the second sample corresponds to the plurality of product characteristic values of the first sample.

2. An analysis apparatus configured to execute an analysis process for electromagnetic noise performance of a sample, comprising:
at least one processor that executes a program stored in a storage medium and/or at least one dedicated circuit, implementing:
a model generation unit configured to generate a model having a noise performance value of the electromagnetic noise performance of a first sample as a response variable and having a plurality of product characteristic values of the first sample as explanatory variables; and
an output unit configured to input a plurality of product characteristic values of the first sample to the explanatory variables of the model, and configured to output data related to analysis of the electromagnetic noise performance of the first sample by using the model.

3. The analysis apparatus according to claim 1, wherein
the product characteristic value includes a circuit characteristic value of a circuit included in the sample.

4. The analysis apparatus according to claim 1, wherein
the model generation unit is configured to calculate a variance ratio and/or a residual sum of squares of the product characteristic value to the noise performance value, and is configured to generate a regression equation of the electromagnetic noise performance by using the variance ratio and/or the residual sum.

5. The analysis apparatus according to claim 1, wherein
the model generation unit is configured to compare the model already generated with the model newly generated and make a model improvement.

6. The analysis apparatus according to claim 1, wherein
the model generation unit is configured to generate respective models for a plurality of frequencies, and
by using the models generated individually for the plurality of frequencies, the output unit is configured to calculate predictive values of the electromagnetic noise performance for the plurality of frequencies respectively.

7. The analysis apparatus according to claim 1, wherein
the at least one processor and/or the at least one dedicated circuit further implements:
a sample extraction unit configured to extract, based on a condition optionally given, the sample having the noise performance value satisfying the condition from among a plurality of samples being output targets by the output unit.

8. The analysis apparatus according to claim 1, wherein
the at least one processor t and/or the at least one dedicated circuit further implements:
a display unit configured to be capable of displaying data related to the analysis process.

9. The analysis apparatus according to claim 1, wherein
the analysis apparatus is communicably connected to a data server accumulating data measured by a measurement apparatus measuring the noise performance value and the product characteristic value, and acquires the noise performance value and the product characteristic value via the data server.

10. An analysis program stored in a non-transitory storage medium to execute an analysis process for electromagnetic noise performance of a sample by using at least one processor,
the analysis program causing the at least one processor to execute:
generating a model having a noise performance value of the electromagnetic noise performance of a first sample as a response variable and having a plurality of product characteristic values of the first sample as explanatory variables; and
inputting a plurality of product characteristic values of a second sample different from the first sample to the explanatory variables of the model, and outputting data related to analysis of the electromagnetic noise performance of the second sample by using the model, wherein the plurality of product characteristic values of the second sample corresponds to the plurality of product characteristic values of the first sample.

11. A method for generating data related to electromagnetic noise performance of a sample, comprising:
generating a model having a noise performance value of the electromagnetic noise performance of a first sample as a response variable and having a plurality of product characteristic values of the first sample as explanatory variables; and
inputting a plurality of product characteristic values of a second sample different from the first sample to the explanatory variables of the model, and generating data related to analysis of the electromagnetic noise performance of the second sample by using the model, wherein the plurality of product characteristic values of the second sample corresponds to the plurality of product characteristic values of the first sample.

12. An analysis apparatus configured to execute an analysis process for electromagnetic noise performance of a sample, comprising:
a memory configured to store data related to analysis of the electromagnetic noise performance regarding samples; and
at least one processor that executes a program stored in a storage medium and/or at least one dedicated circuit, implementing a sample extraction unit configured to extract, with respect to a condition optionally given, a sample having electromagnetic noise performance satisfying the condition from among the samples stored in the memory.
